(19) United States
(12) Patent Application Publication
(10) Pub. No.: US 2019/0286968 A1
(43) Pub. Date: Sep. 19, 2019

(54) COGNITIVE ADAPTION OF RECOMMENDATION SYSTEM

(71) Applicant: INTERNATIONAL BUSINESS MACHINES CORPORATION, Armonk, NY (US)

(72) Inventors: Eric L. Erpenbach, Oronoco, MN (US); Andrew J. Lavery, Austin, TX (US); Richard J. Stevens, Monkton, VT (US); Fernando Jose Suarez Saiz, Armonk, NY (US)

(21) Appl. No.: 15/923,001

(22) Filed: Mar. 16, 2018

(51) Int. Cl. G06N 3/00; G06N 5/04; G06F 17/30; G06F 17/27

(52) U.S. Cl. CPC G06N 3/006; G06N 5/04; H04L 67/12; G06F 17/3043; G06F 17/2785; G06F 17/30401

(57) ABSTRACT

A method, computer system, and a computer program product for a dynamic question and answer (QA) process is provided. The present invention may include receiving an input by a user. The present invention may also include analyzing a user expertise level and an amount of experience based on the received input. The present invention may then include adjusting an expert recommendation to align with the analyzed user expertise level and the amount of experience based on the analyzed user expertise. The present invention may further include providing a plurality of feedback based on the adjusted expert recommendation.

### BACKGROUND

The present invention relates generally to the field of computing, and more particularly to cognitive computing. Cognitive question and answer (QA) systems capture expert level knowledge for a given field for the purpose of sharing the expertise with others who do not have the same level of expertise. Expertise may be determined by an individual's credentials or experience in a particular field.

### SUMMARY

Embodiments of the present invention disclose a method, computer system, and a computer program product for a dynamic question and answer (QA) process. The present invention may include receiving an input by a user. The present invention may also include analyzing a user expertise level and an amount of experience based on the received input. The present invention may then include adjusting an expert recommendation to align with the analyzed user expertise level and the amount of experience based on the analyzed user expertise. The present invention may further include providing a plurality of feedback based on the adjusted expert recommendation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a question and answer (QA) process for dynamic user expertise levels according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for a dynamic QA system. As such, the present embodiment has the capacity to improve the technical field of QA systems by providing an answer (i.e., recommendation, feedback or output) to a user question (i.e., query or search words) based on the user's expertise level. More specifically, a user's skill level may be assessed and considered by a QA recommendation system and an answer may be adapted to the user's skills based on cognitive analytics that determines the expertise level by analyzing the user's historical and current data.

As previously described, cognitive QA systems may capture expert level knowledge for a given field for the purpose of sharing the expertise with others who may or may not share the same level of expertise. Expertise may be determined by an individual's credentials or experience in a particular field. An example of expertise in a particular field may include an oncology treatment advisor solution designed to capture what an expert doctor may prescribe for a given patient that has cancer. Doctors with less expertise (i.e., less credentialed or less experience than an expert) in oncology may prescribe expert level treatment to a patient by using a QA system.

Current QA systems may not consider a user's knowledge, credentials, amount of experience or expertise level. Continuing from the previous example, if a nurse, a resident or a receptionist were to use the QA system for a doctor level expertise, the expert-based QA system may recommend a course of action that the user is not equipped to execute. For example, an oncology treatment advisor system that was trained on what an expert doctor would do in a certain situation may recommend a pneumonectomy (i.e., removal of a lung) as the best course of treatment for a lung cancer patient. However, the user of the QA system may have little or no experience performing such a procedure, may not have the facilities to support such a procedure and may not even be a qualified thoracic surgeon.

User (i.e., an individual or a person) capability of carrying out a recommendation or a set of recommendations may not have been considered. Therefore, it may be advantageous to, among other things, provide a cognitive QA recommendation system using cognitive analytics to analyze user data and to provide answers in a QA system based on a dynamic assessment of each user's experiences and abilities. Additionally, the QA recommendation system may consider the abilities of other users (e.g., another doctor in the same hospital who specializes in a particular procedure) who may be available to a user when a user may not be suited to execute or implement the answer. If a user is not suited to implement the recommendation, then a referral may be made to assist the user in finding the best suited expert to interpret and execute the recommendation correctly.

According to at least one embodiment, a user's expertise level may be assessed by analyzing the user's data. User's data may include both historical data and current real-time data stored or ingested on a database, corpus or knowledgebase. Data may include, for example, a set of available correspondence that consists of both structured and unstructured data associated with the user and a larger set of colleagues belonging to a particular institution, such as a hospital. Correspondence may consist of, for example, doctors' emails, surgeries performed, treatments made, x-rays analyzed, notes created, and conferences attended or conferences where the doctor was a keynote speaker. User, individual or facility input and output sources may include devices, such as, cameras, sensors, Internet of things (IoT) devices, microphones, personal computers, smart telephones, smart tablets, smart watches and communication networks.

Natural language processing and semantic analysis may be used to analyze ingested data from an input or a database associated with, for example, a user, a facility, a business, a university, a hospital or the public. The QA recommendation program may receive and analyze both structured data and unstructured data. Structured data may include data that is highly organized, such as a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content. The received or analyzed data may be processed through NLP to extract information that is meaningful to a user. An NLP system may be created and trained by rules or machine learning.

Semantic analysis may be used to infer the complexity of the questions or searches, such as the meaning and intent of the language, both verbal and non-verbal (e.g., spoken word captured by a microphone and processed for meaning and intent or type written words captured on a word processing document or on a social media account). Semantic analysis may consider current and historical activities of a user to analyze the data being searched with the user data found from many different sources (e.g., various server databases). An example of a server database may include a hospital database, a corporation database, a public government entity database, a bank database or a social media database that stores social media posts. Semantic analysis may also consider syntactic structures at various levels to infer meaning to a user's phrases, sentences and paragraphs. Static data may also be considered through semantic analysis, for example, when raw data is received from software applications and is filtered into meaningful data.

An ontology may be used to connect or map, for example, a user relationship within an entity to verify data. An ontology may include, for example, a web services platform or a software platform that may analyze data semantically based on input data types, output data types and data hierarchies. An example of a semantic analyzer may include web ontology language (OWL) or Protégé.

Recommendations (e.g., expert recommendations) may be analyzed and adjusted from a QA system to better align with the capabilities of the user, or the institution the user is affiliated with. Ingestion of user data may include, for example, user correspondence available from the user and the user's affiliated institution. User data may be assessed to ascertain the level of expertise and experience, for example, that both the user and the institution as a whole possess. If the user is, for example, not affiliated with an institution, the user data may include data, such as social media postings, calendar entries, emails or text messages to ascertain the user's expertise level compared to what the user is querying. Using and gaining insight based on the expertise and experience received may provide data to the QA recommendation program to adjust the advice provided specifically for the user to ensure recommendations align properly with the user capabilities.

The QA recommendation program may analyze, in addition to learning credentials of a user or a given individual, demonstrated abilities of the user or individual and the institution the user is affiliated with based on real world evidence. For example, an analysis includes if a doctor has learned about a given therapy (i.e., treatment) or if the doctor has performed or administered the therapy in the doctor's practice. The analysis may also include the results of the therapy, including if the therapy produced a positive outcome.

One user's input query may be the same as a different user's input query, however, the recommendation output may differ based on the user expertise. For example, a doctor and a non-doctor may query the same question and receive different results based on skill level and expertise. Alternatively, a different input query may yield the same or differing results depending on user expertise. For example, two doctors with similar experience may ask a similar question using different query language and the QA recommendation system may provide the same answer since both doctors' expertise levels are equivalent.

The QA recommendation program may be customized for the end user (i.e., user side) and the end user's consumption based on user abilities and prior experiences. The QA recommendation program may also be customized on the client side (i.e., server side) based on user ability and experiences. For example, a child looks up information regarding a math problem and the output recommendation words are tailored towards terms a child would comprehend. Additionally, if the child had not worked with the level of math being queried, customization may be made based on the topic.

On the user side, NLP may be used, for example, to profile the user's need to understand the user's written or spoken language. On the server side, NLP may be used, for example, to understand what the written or spoken language (i.e., signature language) for the expert is and what signature language the non-expert comprehends. NLP may also, for example, use ontologies based on a particular subject area (e.g., medical, business, finance, legal, government or policy). Analysis of metadata may also be used (e.g., authors of documents or dates). For example, in a university, each academic department contains experts in the particular department, however, based on the way a user interacts with the QA recommendation program and user experience and queries, proper recommendations will be provided and aligned between experts based on subject matter.

The QA recommendation program may operate within secure or private networks (e.g., a hospital, a law firm or a government database, corpus or knowledgebase) and may operate with general public networks (e.g., databases available for general public access). A private network may, for example, be a hospital with a database that stores clinical notes written by the doctors that work in the private network. The clinical notes may be accessible to the hospital employees, however, the public may not have access to the clinical notes.

The QA recommendation program may analyze large volumes of data and may also analyze the user's expertise based on evidence (i.e., data or information on a database or metadata) and not necessarily what the user claims to be an expert in. User demonstration through evidence in the particular field may reveal the level of expertise. Correctness of information may be analyzed using the large volumes of data available. Additionally, if an expert user has, for example, been a doctor practicing in oncology for 30 years, the amount of collateral information available for analysis would be substantial. Collateral information may include many years of presentations, clinical notes, conferences attended, conferences hosted, internal chat conversations, emails, publications or courses taught in the field of oncology.

Available resources to carry out the recommendation may also be analyzed. For example, a doctor may need certain equipment or pharmaceutical medicine to treat a patient and the treatments available may be provided. If the proper treatment or equipment is not available at a hospital, a recommendation may include treating the patient at another hospital or facility. In addition to analyzing the user input query, for example, other doctors in the network or other facilities may be leveraged by the user which creates new recommendations that can also leverage machine learning for the QA recommendation program.

In an alternate embodiment, the QA recommendation program may also provide an output that recommends or suggests a referral to a more expert individual or a more qualified institution when the optimal recommendation is beyond the skillset and experience of the current user who ran a query. The level of expertise of the user, the level of expertise of the other individual and the facilities or supporting infrastructure of the facilities may be analyzed when determining if a particular recommendation aligns with the expertise and infrastructure available. For example, a doctor may be an expert in a particular field but if the doctor is working at a clinic with limited facilities, the doctor would also be limited in terms of the recommendations that could be executed while at the clinic.

Additionally, for example, the QA recommendation program may determine detailed expertise for multiple specific scenarios, such as ascertain if a certain doctor skilled at performing a surgery to remove a tumor would also coordinate radiation treatments as the next step after surgery. Existing evidence documents available in a database may be leveraged, such as documents available on the Oncology Expert Advisor system or database. Leveraging other database documents as a next step may create new recommendations based on the assessment of the abilities to carry out the specific recommendation.

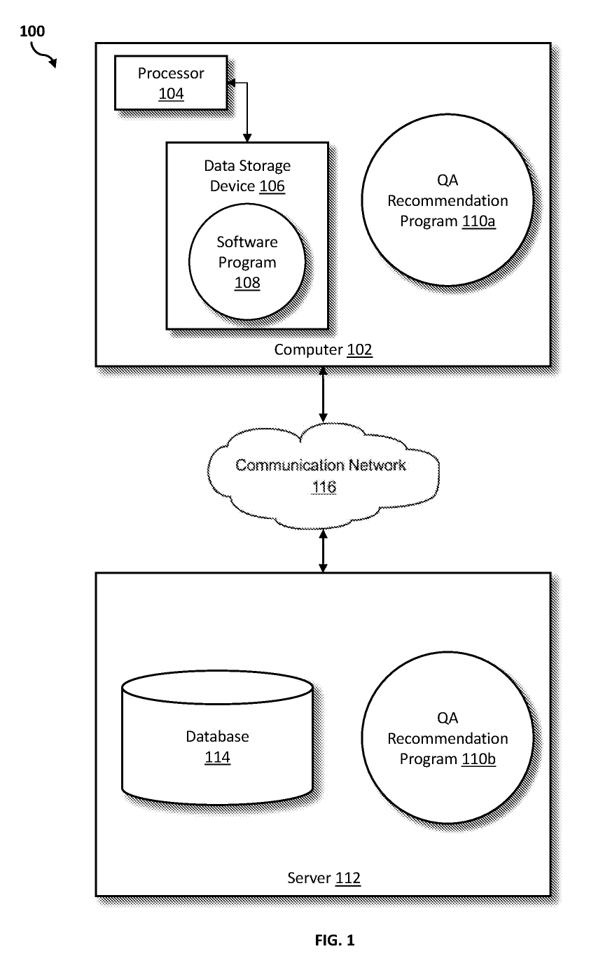

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a QA recommendation program 110a. The networked computer environment 100 may also include a server 112 that is enabled to run a QA recommendation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

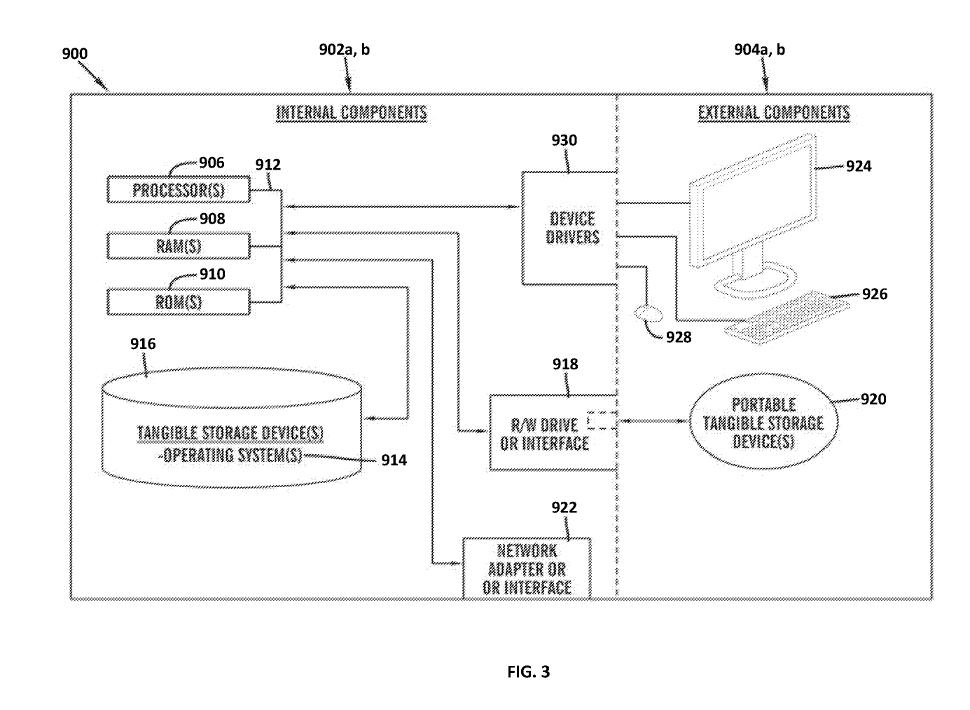

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the QA recommendation program 110a, 110b may interact with a database 114 that may be embedded in various storage devices, such as, but not limited to a computer/mobile device 102, a networked server 112, or a cloud storage service.

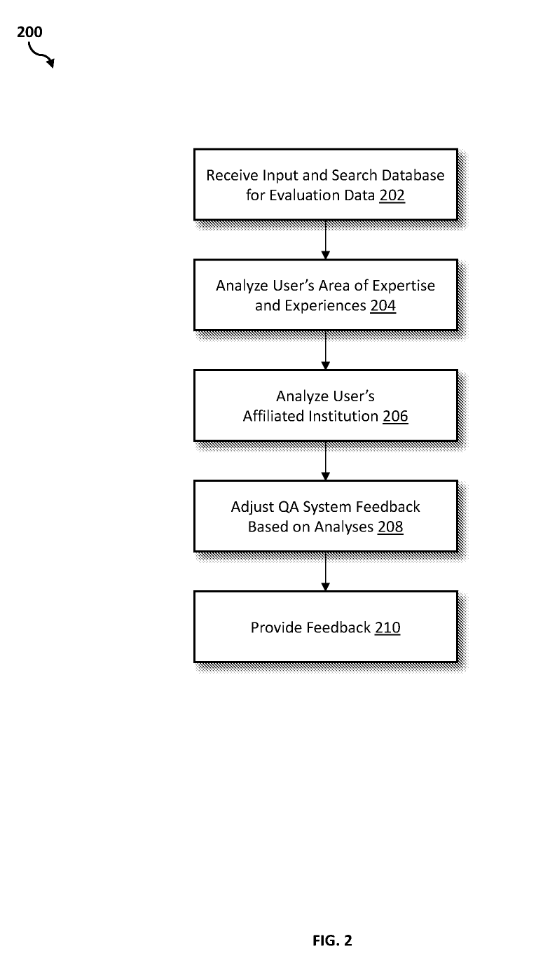

According to the present embodiment, a user using a client computer 102 or a server computer 112 may use the QA recommendation program 110a, 110b (respectively) to receive a recommendation based on user expertise. The QA method for dynamic user expertise levels is explained in more detail below with respect to FIG. 2.

Referring now to FIG. 2, an operational flowchart illustrating the exemplary QA process for dynamic user expertise levels 200 used by the QA recommendation program 110a, 110b according to at least one embodiment is depicted.

At 202, an input is received, and evaluation data is searched for in a database. An input may be provided by the user and may be in the form of a word, a question or query, or a statement. Evaluation data may include stored data from a database that stores the data, for example, for various institutions, companies, applications or the public. Stored data may include, for example, data from a calendar or schedule application, clinical notes, presentations, social media, emails, text messages or chat sessions. Stored data may also include, for example, outcomes from various medical procedures stored on a hospital database. Evaluation data may be searched for based on, for example, a user's skillset or expertise level evidenced by the data stored in various databases when a user queries the QA recommendation program 110a, 110b.

An input may be manually entered by the user or may originate from different software applications. Manual entry examples may include a user inputting via a keyboard a query about treatment for a patient. A verbal input may also be entered into software applications through a device microphone. Another input may be created and entered by the QA recommendation program 110a, 110b which may alter future recommendations or may use machine learning to make further recommendations more robust and knowledgeable. Both user input and input from other individuals may be captured for analysis by the QA recommendation program 110a, 110b. An example of input from another individual may include data the individual posted or responded to on a clinical treatment or correspondence (e.g., an email or a text message).

Then, at 204, the user's area of expertise is analyzed. Assessing the level of expertise and experience of a user may rely on user data, such as correspondence associated with the user and the user's affiliated institution. Correspondence may include data extracted from, for example, doctors' emails, surgeries performed, treatments made, x-rays analyzed, notes created, and conferences attended or conferences where the doctor was a keynote speaker at.

For example, in the healthcare industry, databases that store information for a hospital or a network of hospitals ingest and store data available from an electronic medical record (EMR). Ingested and stored data may include various reports authored by a doctor, surgical notes authored and radiation therapy summaries. Analyzing the doctor's discipline from the ingested and stored data may infer the doctor is a surgeon, a radiation oncologist or a medical oncologist. Specific procedures and therapies prescribed may be analyzed based on demonstrated experience of treating patients, the outcome of the therapies and how often the therapies and prescribed procedures are given by a doctor within the hospital network. Outcomes of the prescribed therapies may be analyzed based on how often the decision or action by the doctor produced positive results and outcomes for the patient. Predicted successful outcomes may be based on, for example, a statistical success rate for a given medical procedure performed by a medical professional. A patient may also use the QA recommendation program 110a, 110b to query a medical condition or disease to receive a recommendation for a doctor or a facility that has performed the recommended procedure with a high success rate of treating the queried medical condition or disease.

Analysis, such as cognitive analysis, may be used and may include machine learning, NLP and semantic analysis of large volumes of data to provide optimal results, for example, for a patient. For example, IBM® Watson Analytics™ (IBM Watson Analytics and all IBM Watson Analytics-based trademarks and logos are trademarks or registered trademarks of International Business Machines Corporation and/or its affiliates) may be used for data analysis.

Next, at 206, the user's affiliated institution is analyzed. Resources may be analyzed for each institution or network of institutions in a user query. Institutional available resources may vary by industry, for example, business, finance, government, medical or agriculture. The institution (i.e., facility or business) infrastructure may be analyzed to determine if a user's capabilities and the facility's capabilities align with the available infrastructure for the optimal recommendation.

For example, a Stage IV, non-small cell lung patient presents to a doctor. Normally, the best treatment for this patient would be use of an immunotherapy, however, the doctor has no experience using such therapies and his clinic is not equipped to cope with the likely adverse events that may occur for patients on the particular therapy. If the likelihood of success is low with the stated conditions, the QA recommendation system may recognize that the doctor and the doctor's available facilities are not adequate to administer the immunotherapy treatment and may recommend a different doctor at a different facility perform the therapy, which may provide a new answer that was not in the database by suggesting to refer the patient to a different specific doctor or clinic that would provide a proper immunotherapy treatment that yields the best outcome for the patient.

At 208, the QA recommendation program 110a, 110b feedback is adjusted based on analyses. Based on the user's expertise and experience assessment in step 204 and the analysis of the user's affiliated institution in step 206, recommendations may be made by, for example, an expert-based advisor solution. The expert-based advisor solution may take the user's abilities and the institution's abilities into account when making or modifying a recommendation to align with the user's evidence-based skillset observed and determined by the QA recommendation program 110a, 110b. For example, the expert-based advisor solution may give a higher preference to a particular therapy for a doctor who has demonstrated experience and proficiency in prescribing the therapy with optimal results for a patient. If the user, who may or may not be a doctor, does not have the capability to perform the therapy, a recommendation may be made to refer the patient to another colleague in the same institution who has demonstrated experience in prescribing the course of treatment that the current user has little or no experience performing.

Additionally, a recommendation may be analyzed and adjusted to include a recommendation or referral to a different institution when, for example, no doctors at the current institution where the user queried from have demonstrated proficiency in a particular optimal therapy for a patient. A network of institutions may be considered, for example, when searching for the best therapy and facility for a patient. The optimal hospital or clinic to send a patient to for a given surgical procedure may be analyzed based on the frequency that the procedure is done at the hospital and the measured outcomes.

Then, at 210, feedback is provided. Feedback may include a recommendation, an output or an answer. Feedback may be provided by the QA recommendation program 110a, 110b to the user in various forms to alert the user that the query has been executed and a recommendation is presented. A message may be, for example, an email message, popup alert or a text message on a computing device. Verbal recommendations may be provided to a user and made, for example, via a speaker on a computing device. Computing devices may include, for example, a computer 102, a smart watch, a smart phone or a smart tablet.

Adjusting an expert-advisor recommendation to align with the cognitive-based user capabilities or facility capabilities may also be used to identify skill gaps for the user and provide references with demonstrated abilities in those skillsets to the user or the institution. When a skill gap is identified, potential mentors or locations may be recommended where a user may acquire the gap in skills from demonstrated experts, which will create a higher skilled workforce for the institution and will create a higher number of, for example, optimal patient outcomes.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 3. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the QA recommendation program 110a in client computer 102, and the QA recommendation program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the QA recommendation program 110a, 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the QA recommendation program 110a in client computer 102 and the QA recommendation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the QA recommendation program 110a in client computer 102 and the QA recommendation program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

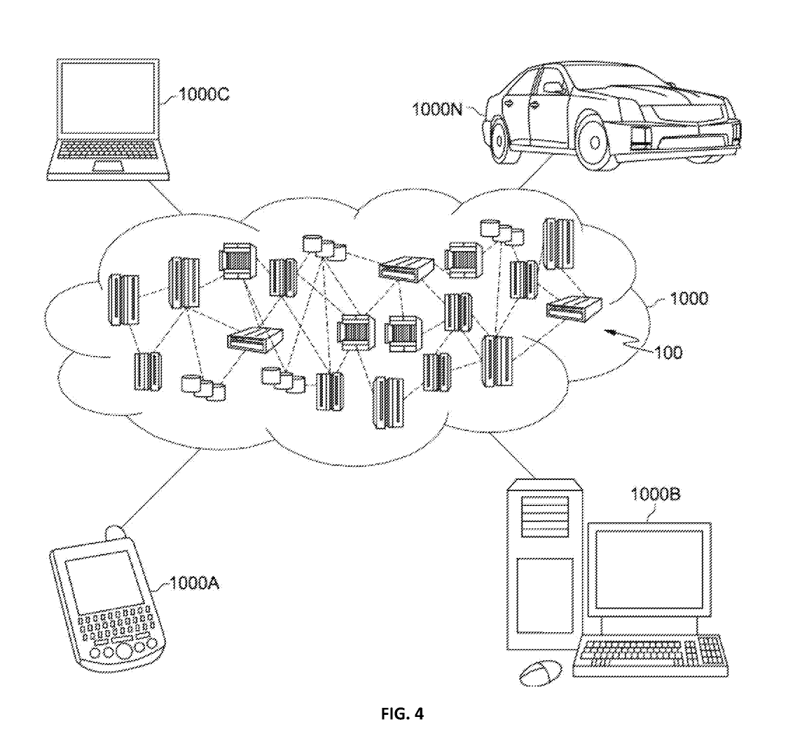

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

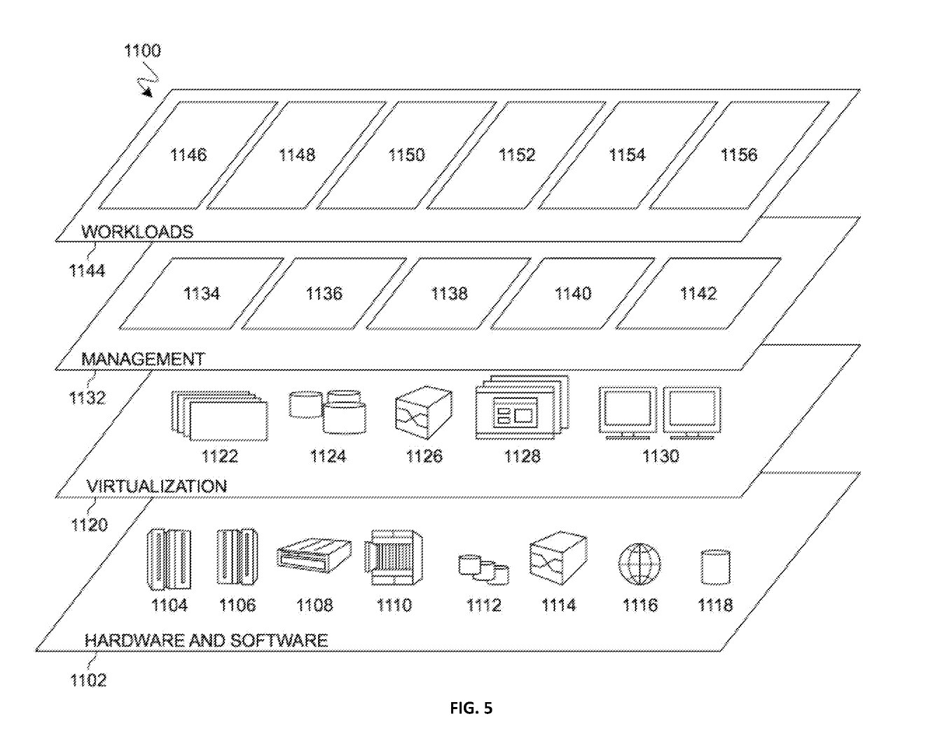

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and a QA recommendation program 1156. A QA recommendation program 110a, 110b provides a way to align expert recommendations to a dynamic range of users' expertise levels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for a dynamic question and answer (QA) process, the method comprising:
receiving an input by a user;
analyzing a user expertise level and an amount of experience based on the received input;
adjusting an expert recommendation to align with the analyzed user expertise level and the amount of experience based on the analyzed user expertise; and
providing a plurality of feedback based on the adjusted expert recommendation.

2. The method of claim 1, wherein the user's expertise level and amount of experience is analyzed based on a subject of a query by the user, and wherein the received input comprises the query.

3. The method of claim 1, wherein the user's expertise level and amount of experience is analyzed based on a plurality of user data stored and evidenced in a plurality of databases.

4. The method of claim 1, wherein natural language processing (NLP) is used to extract a plurality of data from a database that is associated with the input and the user expertise level and amount of experience.

5. The method of claim 2, wherein semantic analysis is used to infer a meaning and an intent of the language of a query made by the user.

6. The method of claim 1, wherein the user is associated with an institution, and wherein the institution is selected from a group consisting of a single institution, a networked plurality of institutions and a non-networked plurality of institutions.

7. The method of claim 6, wherein the user associated with the institution is analyzed, and wherein the analysis includes analyzing a plurality of resources available at the institution and analyzing a plurality of employees available at the institution.

8. A computer system for a dynamic question and answer (QA) process, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving an input by a user;
analyzing a user expertise level and an amount of experience based on the received input;
adjusting an expert recommendation to align with the analyzed user expertise level and the amount of experience based on the analyzed user expertise; and
providing a plurality of feedback based on the adjusted expert recommendation.

9. The computer system of claim 8, wherein the user's expertise level and amount of experience is analyzed based on a subject of a query by the user, and wherein the received input comprises the query.

10. The computer system of claim 8, wherein the user's expertise level and amount of experience is analyzed based on a plurality of user data stored and evidenced in a plurality of databases.

11. The computer system of claim 8, wherein natural language processing (NLP) is used to extract a plurality of data from a database that is associated with the input and the user expertise level and amount of experience.

12. The computer system of claim 9, wherein semantic analysis is used to infer a meaning and an intent of the language of a query made by the user.

13. The computer system of claim 8, wherein the user is associated with an institution, and wherein the institution is selected from a group consisting of a single institution, a networked plurality of institutions and a non-networked plurality of institutions.

14. The computer system of claim 13, wherein the user associated with the institution is analyzed, and wherein the analysis includes analyzing a plurality of resources available at the institution and analyzing a plurality of employees available at the institution.

15. A computer program product for a dynamic question and answer (QA) process, comprising:
one or more computer-readable tangible storage media and program instructions stored on at least one of the one or more computer-readable tangible storage media, the program instructions executable by a processor to cause the processor to perform a method comprising:
receiving an input by a user;
analyzing a user expertise level and an amount of experience based on the received input;
adjusting an expert recommendation to align with the analyzed user expertise level and the amount of experience based on the analyzed user expertise; and
providing a plurality of feedback based on the adjusted expert recommendation.

16. The computer program product of claim 15, wherein the user's expertise level and amount of experience is analyzed based on a subject of a query by the user, and wherein the received input comprises the query.

17. The computer program product of claim 15, wherein the user's expertise level and amount of experience is analyzed based on a plurality of user data stored and evidenced in a plurality of databases.

18. The computer program product of claim 15, wherein natural language processing (NLP) is used to extract a plurality of data from a database that is associated with the input and the user expertise level and amount of experience.

19. The computer program product of claim 16, wherein semantic analysis is used to infer a meaning and an intent of the language of a query made by the user.

20. The computer program product of claim 15, wherein the user is associated with an institution, and wherein the institution is selected from a group consisting of a single institution, a networked plurality of institutions and a non-networked plurality of institutions.
